(19) United States
(12) Patent Application Publication
(10) Pub. No.: US 2024/0086139 A1
(43) Pub. Date: Mar. 14, 2024

(54) MODULAR DISPLAY CONTROL AND METHOD

(71) Applicant: V-Finity, Inc., Saratoga, CA (US)

(72) Inventors: Heng Liu, Sunnyvale, CA (US); Erwin Bellers, Fremont, CA (US)

(21) Appl. No.: 18/466,423

(22) Filed: Sep. 13, 2023

Related U.S. Application Data
(60) Provisional application No. 63/375,524, filed on Sep. 13, 2022.

(51) Int. Cl. G06F 3/14; G06V 20/40; G09G 3/3225

(52) U.S. Cl. CPC G06F 3/1446; G06V 20/49; G09G 3/3225

(57) ABSTRACT

A modular display system includes a processing unit configured to receive and decode video, at least two display segments connected together including a first display segment and a second display segment, where each display segment of the at least two display segments includes a controller and where a controller of the first display segment is communicatively coupled to the processing unit and configured to receive the decoded video, transmit the received decoded video to a second controller of the second display segment, extract a video segment for the first display segment, and cause display of the extracted video segment on the first display segment.

### CROSS-REFERENCE TO RELATED APPLICATIONS

This application claims priority to and incorporates by reference U.S. Provisional Patent Application No. 63/375,524 filed Sep. 13, 2022.

### TECHNICAL FIELD

This disclosure relates to video displays and more particularly but not exclusively to video controllers in multi-segment displays.

### BACKGROUND

Very large displays cannot be created out of one single piece of glass, and therefore multiple display segments are assembled together to create a large display. Various display types can be used for this purpose.

### BRIEF SUMMARY

In one aspect, a modular display system, includes a processing unit configured to receive and decode video, at least two display segments connected together including a first display segment and a second display segment, where each display segment of the at least two display segments includes a controller and where a controller of the first display segment is communicatively coupled to the processing unit and configured to receive the decoded video, transmit the received decoded video to a second controller of the second display segment, extract a video segment for the first display segment, and cause display of the extracted video segment on the first display segment.

A controller of the second display segment is communicatively coupled to the first display segment and configured to receive the decoded video, transmit the received decoded video to a third controller of a third display segment, extract a second video segment for the second display segment, and cause display of the second extracted video segment on the second display segment. Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system in accordance with an example.

FIG. 2 illustrates a modular display of the system in accordance with an example.

FIG. 3 illustrates a controller of the modular display system in accordance with an example.

FIG. 4 illustrates a method of operating the system in accordance with an example.

### DETAILED DESCRIPTION

A larger display panel can be created by a combination of smaller sized panels. Video that is intended for display needs to be properly distributed to each smaller panel (or segment) in an effective manner. This disclosure provides a system and method for distributing video to multiple segments in a large display panel.

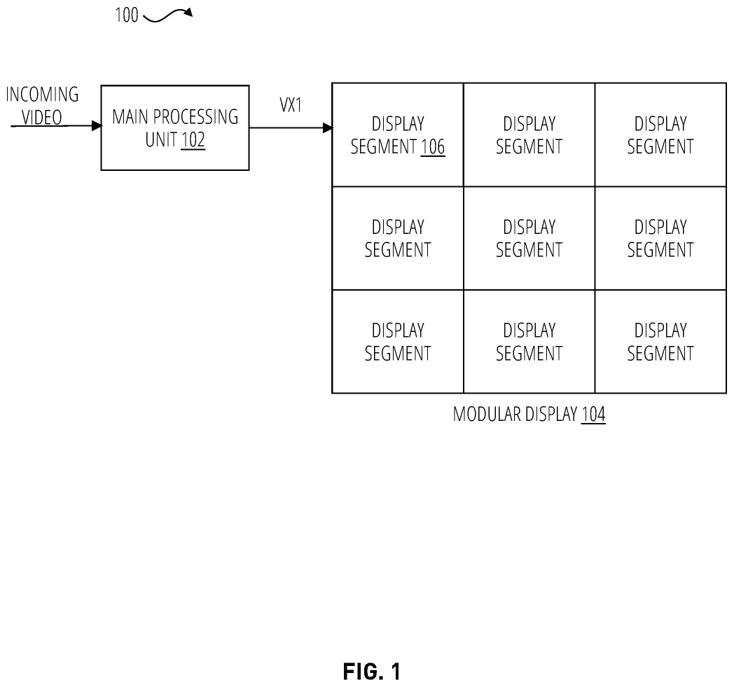

FIG. 1 illustrates a system 100 in accordance with an example. The system 100 comprises a main processing unit 102, a modular display 104, and a plurality of display segments, such as display segment 106. As shown, incoming video/video input is delivered to the main processing unit 102. The main processing unit 102 captures or reads the video coming from an input, which can be HDMI, USB, IP-based, DP, CVBS, Component, OTT, OTA, etc., performs processing, generally to conduct decoding and optionally improve the picture quality of the video, adapt it to the characteristics of the display, and distributes the video over a display interface, which is typically Vx1 or Low Voltage Differential Signaling (LVDS). Note that this video processing is applied to the full picture.

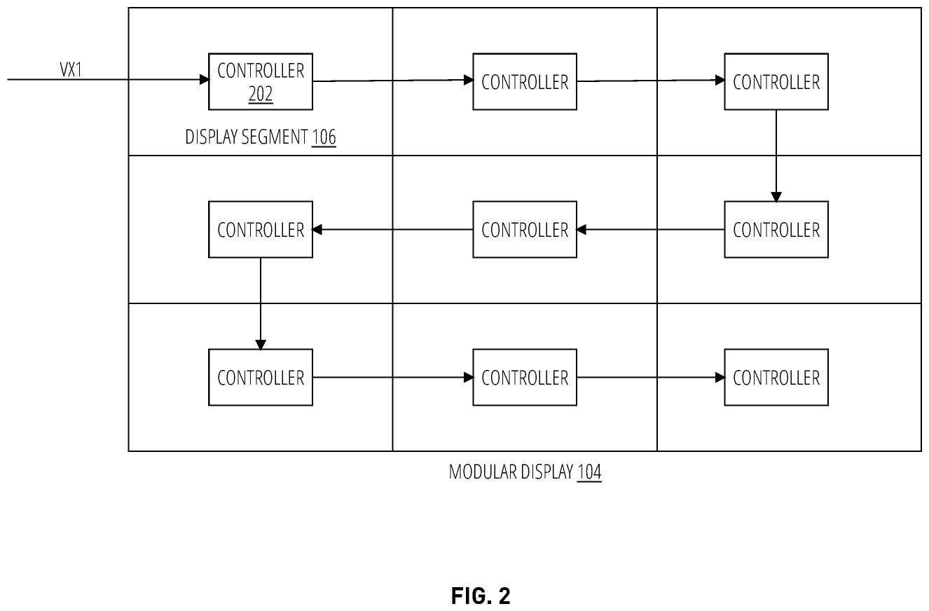

FIG. 2 illustrates a modular display 104 of the system 100 in accordance with an example. The modular display 104 comprises multiple display segments, e.g., display segment 106, and each display segment includes a controller, e.g., controller 202. Each controller receives the video over a display interface (e.g., Vx1) and redistributes it (unaltered) to its neighbor in a daisy chain ordering. Other orderings are also feasible. Accordingly, each controller receives at least a full resolution picture over the incoming Vx1 interface and passes it along to a next controller situated in a neighboring display segment. The last display segment in a daisy chain need not forward the video. The controller 202 can be a single-chip solution, such as an Application Specific Integrated Circuit (ASIC) or Field Programmable Gate Array (FPGA).

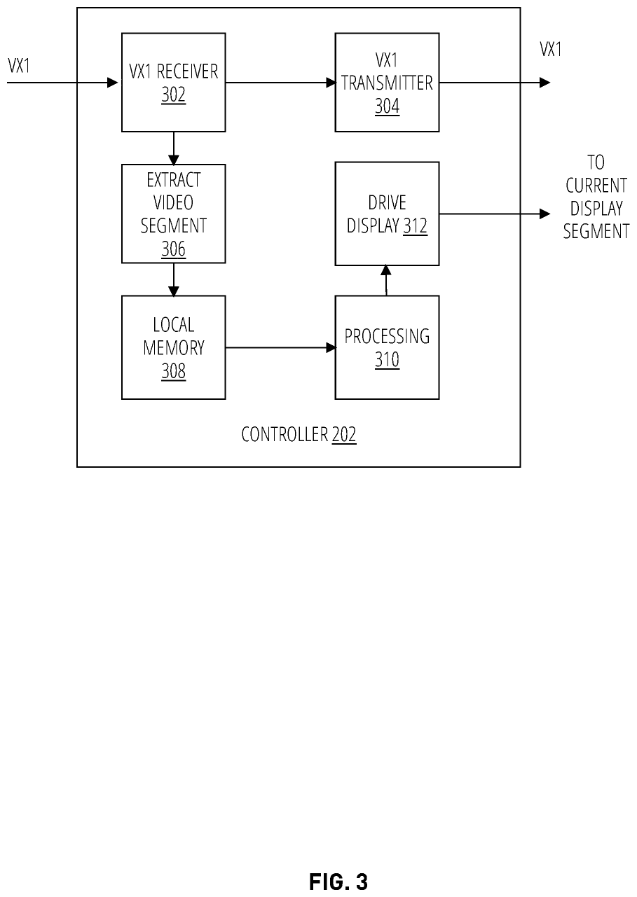

FIG. 3 illustrates a controller of the modular display 104 in accordance with an example. The controller 202 comprises a Vx1 receiver 302, a Vx1 transmitter 304, an extract video segment 306, a local memory 308, a processing 310, and a drive display 312. The controller 202 does not only receive the incoming full resolution video over input Vx1 and resends it over output Vx1, but also extracts and processes part of the video relevant for current display segment as illustrated in FIG. 3. The display segment can be a passive matrix or an active matrix configuration. In an example, an active matrix is better matched with Vx1 interface since they are most widely used in consumer TVs. In another example, the Vx1 interface is designed to communicate with source and gate drivers in the active matrix circuitry. In another example, the display segment is active matrix without bezel that can be tiled with other segments seamlessly. Technology that can eliminate the bezel includes moving the electronics at the edge of the display to the backside of the display and connecting the electronics to the pixels through a through-glass via. In another example, in place of self-emitting pixels, the modular display 104 can comprise reflective pixels, e.g., e-ink.

The Vx1 receiver 302 receives the Vx1 video data and makes the data available internally for further processing. As can be seen it is passed along to the Vx1 transmitter 304 in order to pass the signal to the next display segment and also passes the video to the extract video segment 306 unit. Each controller is aware of which part of the video window it needs to process.

The cropped video necessary for processing may be locally stored in a buffer, e.g, in the local memory 308. After the capture of the video segment, it is potentially being processed at the processing 310 unit, after which it is being prepared to drive the local display segment panel by the drive display 312 unit. Note that it is not essential that the video undergoes processing or is stored locally. However, the controller does extracts the relevant video and drives the local display segment panel. Furthermore, the full resolution video is passed along to the neighboring segment.

Each display segment controller needs to know what video segment to extract. This can be done in a variety of ways. One option is to number all controllers automatically in sequence by using a daisy chained control interface. The main processing unit 102 sends out the start number over the SPI interface to the first display segment controller, e.g. ‘0’. The first controller stores this number locally, then updates it (i.e. adding ‘1’), and sends this to the next display segment controller, all the way till the last one.

For each final display, the configuration is fixed and known a priori. Therefore, once the above is known, each segment can be instructed to fetch the video accordingly to the known configuration.

If the configuration is not known upfront, then an installer can highlight one segment at the time (using the control interface), and the installer can create a map how each segment fits in the total picture. Ones the full map is created each segment can be notified to which part of the video it belongs.

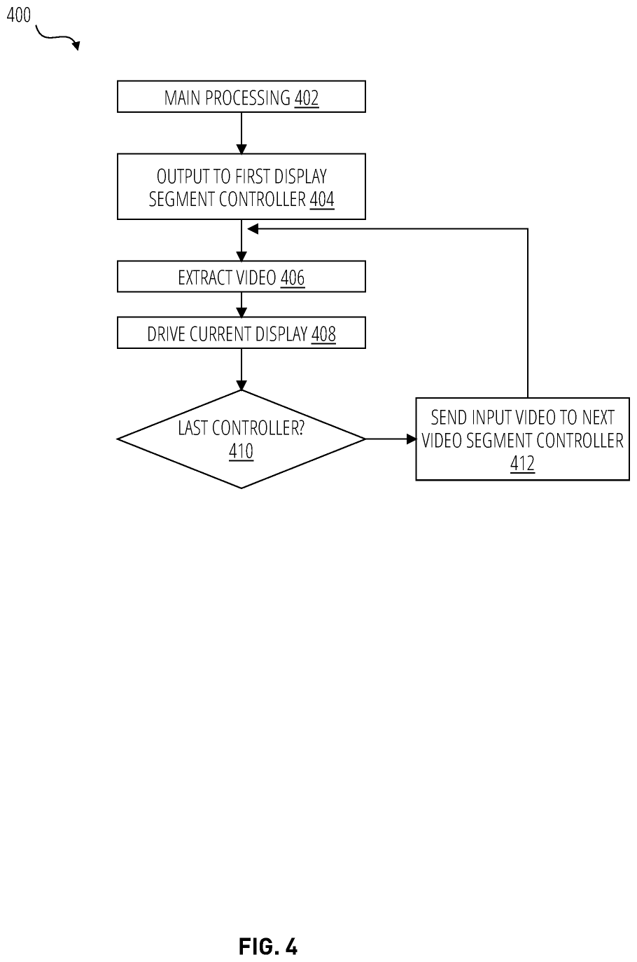

FIG. 4 illustrates a method 400 of operating the system 100 in accordance with an example. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes main processing at block 402; outputting to first display segment controller at block 404; extracting video for a current segment at block 406; driving current display at block 408; if not the last controller, then sending the input video the next video segment controller at block 412 and then repeating the extracting at block 406 and driving the current display at block 408.

In view of the disclosure above, various examples are set forth below. It should be noted that one or more features of an example, taken in isolation or combination, should be considered within the disclosure of this application.

1. A modular display system, comprising:
a processing unit configured to receive and decode video; and
at least two display segments connected together including a first display segment and a second display segment, wherein each display segment of the at least two display segments includes a controller and wherein a controller of the first display segment is communicatively coupled to the processing unit and configured to
receive the decoded video;
transmit the received decoded video to a second controller of the second display segment;
extract a video segment for the first display segment; and
cause display of the extracted video segment on the first display segment.

2. The modular display system of example 1, wherein a controller of the second display segment is communicatively coupled to the first display segment and configured to: receive the decoded video;
transmit the received decoded video to a third controller of a third display segment;
extract a second video segment for the second display segment; and
cause display of the second extracted video segment on the second display segment.

3. The modular display system of any of the preceding examples, wherein the first display segment comprises a buffer configured to buffer the extracted video segment to compensate for delay of display of the second extracted video segment at the second display segment.

4. The modular display system of any of the preceding examples, wherein the controller of the first display receives the decoded video via a Vx1 interface.

5. The modular display system of any of the preceding examples, wherein the at least two display segments are configured as active matrix including data and scan lines connected to at least one source and at least one gate driver.

6. The modular display system of any of the preceding examples, wherein the at least one source and the at least one gate driver are electrically connected on a backside of one of the at least two display segments through a through-hole via, e.g., a through-glass via.

7. The modular display system of any of the preceding examples, wherein the at least two display segments include pixels connected in series.

8. The modular display system of any of the preceding examples, wherein the at least two display segments include self-emitting pixels.

9. The modular display system of any of the preceding examples, wherein the at least two display segments include reflective pixels.

10. The modular display system of any of the preceding examples, wherein each controller is electrical connected on a backside of the at least two display segments through a through-hole via, e.g., a through-glass via.

11. A modular display system method, the system comprising a processing unit and at least two display segments connected together including a first display segment and a second display segment, wherein each display segment of the at least two display segments includes a controller and wherein a controller of the first display segment is communicatively coupled to the processing unit, and wherein the method comprises:
receiving and decoding video with the processing unit;
receiving, with the first display segment controller, the decoded video;
transmitting, with the first display segment controller, the received decoded video to a second controller of the second display segment;
extracting, with the first display segment controller, a video segment for the first display segment; and
causing, with the first display segment controller, display of the extracted video segment on the first display segment.

12. The method of example 11, wherein a controller of the second display segment is communicatively coupled to the first display segment and the method further comprises:
receiving, with the second display segment controller, the decoded video;
transmitting, with the second display segment controller, the received decoded video to a third controller of a third display segment;
extracting, with the second display segment controller, a second video segment for the second display segment; and
causing, with the second display segment controller, display of the second extracted video segment on the second display segment.

13. The method of any of the preceding examples, wherein the first display segment comprises a buffer and the method further comprises buffering, with the buffer, the extracted video segment to compensate for delay of display of the second extracted video segment at the second display segment.

14. The method of any of the preceding examples, wherein the controller of the first display receives the decoded video via a Vx1 interface.

15. The method of any of the preceding examples, wherein the at least two display segments are configured as active matrix including data and scan lines connected to at least one source and at least one gate driver.

16. The method of any of the preceding examples, wherein the at least one source and the at least one gate driver are electrically connected on a backside of one of the at least two display segments through a through-hole via, e.g., a through-glass via.

17. The method of any of the preceding examples, wherein the at least two display segments include pixels connected in series.

18. The method of any of the preceding examples, wherein the at least two display segments include self-emitting pixels.

19. The method of any of the preceding examples, wherein the at least two display segments include reflective pixels.

20. The method of any of the preceding examples, wherein each controller is electrical connected on a backside of the at least two display segments through a through-hole via, e.g., a through-glass via.

What is claimed is:

1. A modular display system, comprising:
a processing unit configured to receive and decode video; and
at least two display segments connected together including a first display segment and a second display segment, wherein each display segment of the at least two display segments includes a single-chip controller and wherein a controller of the first display segment is communicatively coupled to the processing unit and configured to
receive the decoded video;
transmit the received decoded video to a second controller of the second display segment;
extract a video segment for the first display segment; and
cause display of the extracted video segment on the first display segment.

2. The modular display system of claim 1, wherein a controller of the second display segment is communicatively coupled to the first display segment and configured to:
receive the decoded video;
transmit the received decoded video to a third controller of a third display segment;
extract a second video segment for the second display segment; and
cause display of the second extracted video segment on the second display segment.

3. The modular display system of claim 2, wherein the first display segment comprises a buffer configured to buffer the extracted video segment to compensate for delay of display of the second extracted video segment at the second display segment.

4. The modular display system of claim 1, wherein the controller of the first display receives the decoded video via a Vx1 interface.

5. The modular display system of claim 1, wherein the at least two display segments are configured as active matrix including data and scan lines connected to at least one source and at least one gate driver.

6. The modular display system of claim 5, wherein the at least one source and the at least one gate driver are electrically connected on a backside of one of the at least two display segments through a through-hole via.

7. The modular display system of claim 1, wherein the at least two display segments include pixels connected in series.

8. The modular display system of claim 1, wherein the at least two display segments include self-emitting pixels.

9. The modular display system of claim 1, wherein the at least two display segments include reflective pixels.

10. The modular display system of claim 1, wherein each controller is electrical connected on a backside of the at least two display segments through a through-hole via.

11. A method for use in a modular display system, the system comprising a processing unit and at least two display segments connected together including a first display segment and a second display segment, wherein each display segment of the at least two display segments includes a single-chip controller and wherein a controller of the first display segment is communicatively coupled to the processing unit, and wherein the method comprises:
receiving and decoding video with the processing unit;
receiving, with the first display segment controller, the decoded video;
transmitting, with the first display segment controller, the received decoded video to a second controller of the second display segment;
extracting, with the first display segment controller, a video segment for the first display segment; and
causing, with the first display segment controller, display of the extracted video segment on the first display segment.

12. The method of claim 11, wherein a controller of the second display segment is communicatively coupled to the first display segment and the method further comprises:
receiving, with the second display segment controller, the decoded video;
transmitting, with the second display segment controller, the received decoded video to a third controller of a third display segment;
extracting, with the second display segment controller, a second video segment for the second display segment; and
causing, with the second display segment controller, display of the second extracted video segment on the second display segment.

13. The method of claim 12, wherein the first display segment comprises a buffer and the method further comprises buffering, with the buffer, the extracted video segment to compensate for delay of display of the second extracted video segment at the second display segment.

14. The method of claim 11, wherein the controller of the first display receives the decoded video via a Vx1 interface.

15. The method of claim 11, wherein the at least two display segments are configured as active matrix including data and scan lines connected to at least one source and at least one gate driver.

16. The method of claim 15, wherein the at least one source and the at least one gate driver are electrically connected on a backside of one of the at least two display segments through a through-hole via.

17. The method of claim 11, wherein the at least two display segments include pixels connected in series.

18. The method of claim 11, wherein the at least two display segments include self-emitting pixels.

19. The method of claim 11, wherein the at least two display segments include reflective pixels.

20. The method of claim 11, wherein each controller is electrical connected on a backside of the at least two display segments through a through-hole via.
